(19) United States
(12) Patent Application Publication
(10) Pub. No.: US 2026/0141603 A1
(43) Pub. Date: May 21, 2026

(54) METHOD AND APPARATUS FOR TRAINING LIP-SYNC VIDEO GENERATION MODEL

(71) Applicant: ELECTRONICS AND TELECOMMUNICATIONS RESEARCH INSTITUTE, Daejeon (KR)

(72) Inventors: Gyeong-Moon Park, Daejeon (KR); Jae-Ho Lee, Daejeon (KR); Yoonhyung Kim, Daejeon (KR)

(21) Appl. No.: 19/387,954

(22) Filed: Nov. 13, 2025

(30) Foreign Application Priority Data
Nov. 19, 2024 (KR) 10-2024-0164742

(51) Int. Cl. G06T 13/20; G06T 13/80; G06T 15/08; G10L 15/25

(52) U.S. Cl. CPC G06T 13/205; G06T 13/80; G06T 15/08; G10L 15/25

(57) ABSTRACT

Provided are a method and apparatus for training a lip-sync video generation model, specifically, a method and apparatus for training a lip-sync video generation model based on a deep learning model, according to which, when there is an image of a person and audio is given, a realistic image in which the shape of the lips of the person is synchronized with the given audio is generated.

### CROSS-REFERENCE TO RELATED APPLICATION

This application claims priority to and the benefit of Korean Patent Application No. 10-2024-0164742, filed on Nov. 19, 2024, the disclosure of which is incorporated herein by reference in its entirety.

### BACKGROUND

### 1. Field of the Invention

The present invention relates to a method and apparatus for training a lip-sync video generation model based on a deep learning model in which, when there is an image of a person and arbitrary audio is given, a realistic video in which the shape of the lips of the person is synchronized with the given audio is generated.

This work was supported by the Institute of Information & Communications Technology Planning & Evaluation (IITP) Grant through the Korea Government (MSIT), Development of Semi-Supervised Learning Language Intelligence Technology and Korean Tutoring Service for Foreigners, under Grant 2019-0-00004.

### 2. Description of Related Art

Audio-based realistic lip-sync video generation technology has been gaining attention and developing due to its wide range of applications, such as digital avatars, dubbing, and online education.

Until now, most audio-based realistic lip-sync video generation technologies have been based on generative adversarial networks (GANs) and have had difficulty in generating realistic images due to the lack of 3D structural information. Recently, there has been growing research into technologies that generate more realistic lip-sync images using implicit 3D structural information based on neural radiance fields (NeRFs).

However, conventional NeRF-based lip-sync video generation technologies (see [2]) perform processing by simply concatenating image features and audio features, and such methods fail to dynamically identify the complex relationships between image features and audio features, resulting in inaccurate lip movements for given audio, which affects not only the lips but also the overall face, thereby degrading the visual quality of the generated results.

### SUMMARY OF THE INVENTION

The present invention aims to provide a method and apparatus for training a lip-sync video generation model based on an image-audio multi-modality, that, when an image of a person and an arbitrary audio are given, enable a realistic image in which the audio and the lip shape of the person are synchronized to be generated.

Specifically, the present invention aims to provide a method and apparatus for training a lip-sync video generation model, in which a cross-attention operation process of visual features and audio features is added to a lip-sync video generation model, and the model is trained using a multi-level SyncNet loss function and a wavelet loss function such that audio and an image are synchronized by focusing only on a mouth shape and the visual quality of the generated result in a high-frequency region is enhanced.

The technical objectives of the present invention are not limited to the above, and other objectives may become apparent to those of ordinary skill in the art based on the following description.

A method of training a lip-sync video generation model according to an embodiment of the present invention is performed by an apparatus for training a lip-sync video generation model.

According to an aspect of the present invention, there is provided a method of training a lip-sync video generation model, which includes: generating, by an apparatus for training a lip-sync video generation model, a visual feature and an audio feature using a deep learning-based neural radiance field (NeRF) and an audio feature extractor based on lip-sync target data including visual data and audio data; combining, by the apparatus, the visual feature and the audio feature through a cross-attention operation to generate a visual-audio feature; upsampling, by the apparatus, the visual-audio feature to generate an output image; and performing, by the apparatus, training by inputting the output image to a predetermined loss function and updating parameters of the lip-sync video generation model based on a value of the predetermined loss function.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating the configuration of an apparatus for training a lip-sync video generation model according to an embodiment of the present invention;

FIG. 2 is a flowchart for describing a method of training a lip-sync video generation model according to an embodiment of the present invention; and

FIG. 3 is a diagram showing the architecture of a lip-sync video generation model according to an embodiment of the present invention.

### DETAILED DESCRIPTION OF EXEMPLARY EMBODIMENTS

The advantages and features of the present invention and ways of achieving them will become readily apparent with reference to the detailed description of the following embodiments in conjunction with the accompanying drawings. However, the present invention is not limited to such embodiments and may be embodied in various forms. The embodiments to be described below are provided only to complete the disclosure of the present invention and assist those of ordinary skill in the art in fully understanding the scope of the present invention, and the scope of the present invention is defined only by the appended claims. Terms used herein are used to aid in the description and understanding of the embodiments and are not intended to limit the scope and spirit of the present invention. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when a first element is referred to as being “connected” or “coupled” to a second element, the first element can be directly connected or coupled to the second element or intervening elements may be present. In contrast, when an element is referred to as being “directly connected” or “directly coupled” to another element, there are no intervening elements present. Other words used to describe the relationships between elements should be interpreted in a like fashion (i.e., “between” versus “directly between,” “adjacent” versus “directly adjacent,” etc.).

In this specification, an image is any visual element that may be displayed on a screen or display device and stored in memory. In this specification, images may include a moving image, a still image, a still cut (a photograph), and the like. A moving image may be composed of a plurality of frames, and each frame may include a plurality of layers or regions. An image may be a two-dimensional image or a three-dimensional image.

In the description of the present invention, when it is determined that a detailed description of related technology may unnecessarily obscure the gist of the present invention, the detailed description will be omitted

The references for the present invention are listed below. The entire contents of reference [1] are incorporated herein by reference.
[1] Ah-Hyung Shin, Jae-Ho Lee, Jiwon Hwang, Yoonhyung Kim, Gyeong-Moon Park, “Wav2NeRF: Audio-driven realistic talking head generation via wavelet-based NeRF,” Image and Vision Computing, Volume 148, 2024, https://doi.org/10.1016/j.imavis.2024.105104.
[2] Guo, Yudong, et al. “Ad-nerf: Audio driven neural radiance fields for talking head synthesis.” Proceedings of the IEEE/CVF international conference on computer vision. 2021.
[3] Prajwal, K. R., et al. “A lip sync expert is all you need for speech to lip generation in the wild.” Proceedings of the 28th ACM international conference on multimedia. 2020.

Hereinafter, embodiments of the present invention will be described with reference to the accompanying drawings in detail. For better understanding of the present invention, the same reference numerals are used to refer to the same elements throughout the description of the drawings.

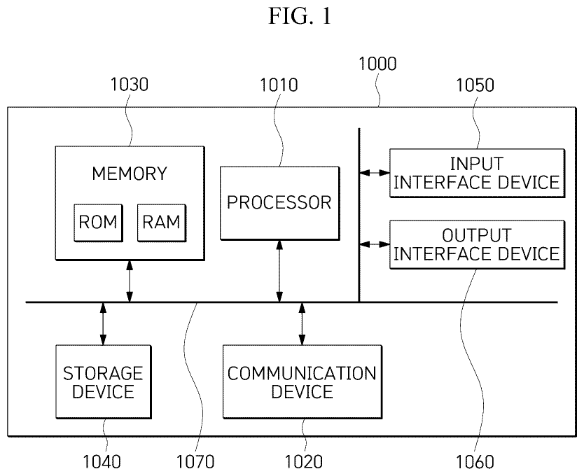

FIG. 1 is a block diagram illustrating the configuration of an apparatus for training a lip-sync video generation model according to an embodiment of the present invention.

An apparatus 1000 for training a lip-sync video generation model according to an embodiment of the present invention may be implemented in the form of a computer system as shown in FIG. 1.

Referring to FIG. 1, the apparatus 1000 for training a lip-sync video generation model may include at least one of a processor 1010, a memory 1030, an input interface device 1050, an output interface device 1060, and a storage device 1040 that perform communication through a bus 1070. The apparatus 1000 for training a lip-sync video generation model may further include a communication device 1020 coupled to a network. The processor 1010 may be a central processing unit (CPU) or a semiconductor device for executing instructions stored in the memory 1030 and/or storage device 1040. The memory 1030 and the storage device 1040 may include various forms of volatile or nonvolatile media. For example, the memory 1030 may include a read-only memory (ROM) or a random-access memory (RAM). In an embodiment of the present invention, the memory 1030 may be located inside or outside the processor 1010 and may be connected to the processor 1010 through various known means. The memory 1030 may include various forms of volatile or nonvolatile media, for example, may include a ROM or a RAM.

Accordingly, embodiments of the present invention may be embodied as a method implemented by a computer or as a non-transitory computer-readable medium in which computer-executable instructions are stored. In one embodiment, when executed by the processor 1010, computer-readable instructions may perform a method according to at least one aspect of the present disclosure.

The communication device 1020 may transmit or receive wired signals or wireless signals.

In addition, the method of training the lip-sync video generation model according to the embodiment of the present invention may be implemented in the form of program instructions executable by various computer devices and may be recorded on a computer-readable medium.

The computer readable medium may be provided with program instructions, data files, data structures, and the like alone or in combination. The program instructions recorded on the computer readable medium may be specially designed and constructed for the purposes of the present invention or may be well known and available to those skilled in the art of computer software. Examples of the computer readable storage medium include hardware devices configured to store and execute program instructions. Examples of the computer readable storage medium include magnetic media such as hard disks, floppy disks, and magnetic tape, optical media such as a compact disc read-only memory (CD-ROM) and a digital video disk (DVD), magneto-optical media such as floptical disks, a ROM, a RAM, a flash memory, etc. The program instructions include not only machine language code made by a compiler but also high level code that may be used by an interpreter or the like which is executed by a computer.

The processor 1010 may execute the instructions stored in the memory 1030 or the storage device 1040 to generate a visual feature and an audio feature using a deep learning-based neural radiance field (NeRF) and an audio feature extractor based on lip-sync target data including visual data and audio data, combine the visual feature and the audio feature through a cross-attention operation to generate a visual-audio feature, upsample the visual-audio feature to generate an output image, and input the output image to a predetermined loss function and update parameters of the lip-sync video generation model based on a value of the predetermined loss function.

The apparatus 1000 for training a lip-sync video generation model shown in FIG. 1 is based on an embodiment, components of the apparatus 1000 for training a lip-sync video generation model according to the present invention are not limited to those shown in FIG. 1, and some components may be added, changed, or omitted as needed.

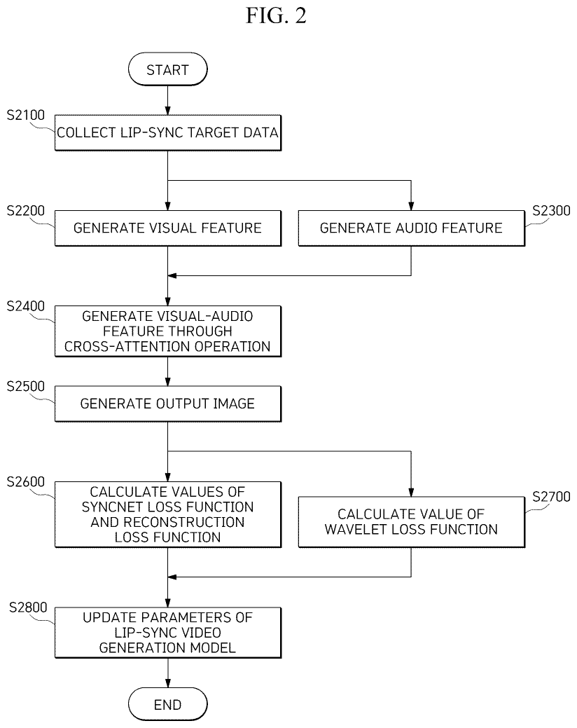

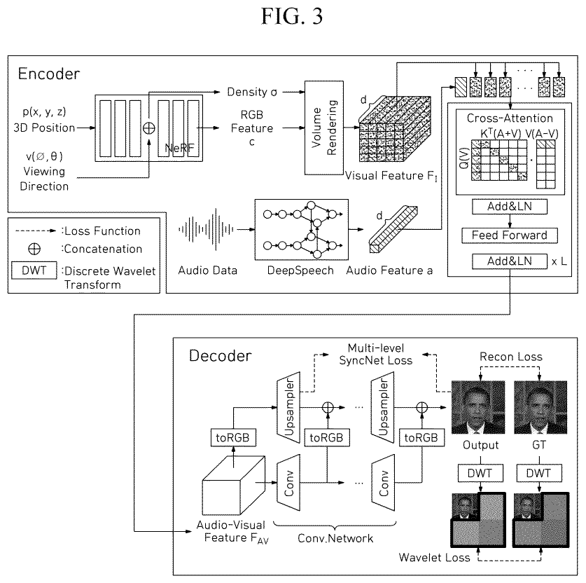

FIG. 2 is a flowchart for describing a method of training a lip-sync video generation model according to an embodiment of the present invention, and FIG. 3 is a diagram showing the architecture of a lip-sync video generation model according to an embodiment of the present invention.

The method of training a lip-sync video generation model shown in FIG. 2 may be performed by the apparatus 1000 for training a lip-sync video generation model.

Referring to FIG. 2, the method of training a lip-sync video generation model according to an embodiment of the present invention includes operations S2100 to S2800. The method of training a lip-sync video generation model shown in FIG. 2 is based on an embodiment, operations of the method of training a lip-sync video generation model according to the present invention are not limited to the embodiment shown in FIG. 2, and some operations may be added, changed, or omitted as needed.

The lip-sync video generation model shown in FIG. 3 includes an encoder and a decoder. The encoder is a model that receives lip-sync target data (visual data and audio data) and generates a visual-audio feature, and the decoder is a model that receives the visual-audio feature and generates an output image (a lip-sync image).

Hereinafter, a method of training a lip-sync video generation model according to an embodiment of the present invention and a lip-sync video generation model to which the training method is applied will be described with reference to FIGS. 2 and 3.

Operation S2100 is an operation of collecting lip-sync target data.

The communication device 1020 or the input interface device 1050 of the apparatus 1000 for training a lip-sync video generation model according to an embodiment of the present invention collects lip-sync target data from the outside and stores the collected lip-sync target data in the memory 1030 or the storage device 1040.

In the present invention, the lip sync target data is data input to the lip sync video generation model and includes visual data and audio data. In the present invention, the visual data includes a plurality of images captured from various viewpoints, a 3D position of the viewpoints, and a viewing direction. Here, the viewing direction is a direction from a camera toward a point on an object.

The processor 1010 may read the lip sync target data stored in the memory 1030 or the storage device 1040.

Operation S2200 is an operation of generating a visual feature.

The processor 1010 generates a visual feature F_{I} through a neural radiance field (NeRF) and volume rendering based on the visual data included in the lip sync target data.

The processor 1010 inputs visual data into a NeRF to generate a volume density (hereinafter referred to as “a density”) and an RGB feature and generates a visual feature through rendering (“volume rendering” shown in FIG. 3) based on the density and the RGB feature. The visual feature is considered information of a compressed scene.

The NeRF is an operation structure composed of a multi-layer perceptron (MLP, f_{Θ}) and expresses a static scene using a density σ and an RGB feature (c, a set of color values). The processor 1010 inputs a plurality of images included in the visual data, 3D position information (p=(x, y, z)) of a viewpoint corresponding to each image, and a viewing direction (v=(φ, θ)) into the multi-layer perceptron f_{Θ} to generate an RGB feature c and a density σ. The processor 1010 generates a visual feature F_{I} through rendering based on the RGB feature c and the density σ.

The lip-sync video generation model according to the embodiment of the present invention uses a modified NeRF-based encoder-decoder structure as shown in FIG. 3 to generate a real-time lip-sync image. The lip-sync video generation model receives visual data through a NeRF-based encoder, outputs a high-dimension (more than 3 dimensions, e.g., 256 dimensions) RGB feature and a density, and generates a visual feature F_{I} through a rendering process. When the visual feature F_{I} is input to a convolutional network included in the decoder, a single image may be completed.

Operation S2300 is an operation of generating an audio feature.

The processor 1010 inputs audio data included in the lip-sync target data into a pre-trained audio feature extractor (DeepSpeech) to generate an audio feature a.

For reference, in FIG. 3, the numbers of the dimensions d of the visual feature F_{I} and the dimensions d of the audio feature a may be the same (e.g., 256).

Operation S2400 is an operation of generating a visual-audio feature.

The present invention proposes a method of combining a visual feature and an audio feature using cross attention to generate an accurate lip-sync image (an output image).

First, the processor 1010 reshapes the dimensions of the visual feature F_{I} and the audio feature a to generate a visual token X_{I} and an audio token. Then, the processor 1010 performs a cross-attention operation by setting the visual token as a query and setting a visual-audio token X_{AV}=[a; X_{I}], which is a combination of the visual token and the audio token, as a key and a value. The process of the cross-attention operation is described in Equations 1 and 2.

$$\{ \begin{matrix}{Q}_{v} = {X}_{I} {W}_{Q} \\ {K}_{av} = {X}_{AV} {W}_{K} \\ {V}_{av} = {X}_{AV} {W}_{V}\end{matrix} \qquad [ Equation 1 ]$$

$$A = soft max ( \frac{{Q}_{v} {K}_{av}^{T}}{\sqrt{d}} ) {V}_{av} \qquad [ Equation 2 ]$$

In Equations 1 and 2, Qᵥ, Kₐᵥ, and Vₐᵥ represent a query, a key, and a value of cross-attention, respectively, and Wo, WK, and Wy represent linear projection weights for adjusting the query, key, and value. The processor 1010 may initialize the linear projection weights according to a uniform distribution (e.g., Xavier uniform distribution) and may then update the linear projection weights through a training operation of S2800.

The processor 1010 inputs a cross-attention output A obtained through the cross-attention operation into a transformer layer including a normalization layer and a feed-forward network to generate a visual-audio feature. This process allows the visual-audio feature to reflect the result of dynamically identifying the complex relationship between the visual feature and the audio feature.

Operation S2500 is an operation of generating an output image.

The processor 1010 inputs a visual-audio feature (FAV) obtained through a network utilizing cross-attention into an upsampling model composed of a multi-layer convolution network including an upsampler to generate an output image Output Î ∈

[symbol]

The purpose of the decoder is to upsample the low-resolution visual-audio feature FAV to generate the final output image. The upsampler of the decoder may be a part that performs simple bilinear upsampling. In addition, “Conv.” in FIG. 3 is a part that adds the upsampling result and the visual-audio feature and serves to increase the spatial resolution of the output image.

For reference, bilinear upsampling operates based on bilinear interpolation. That is, in bilinear interpolation, upsampling is performed using linear interpolation (estimation using a proportional equation according to the straight-line distance) for 2 dimensions.

Operation S2600 is an operation of calculating values of a SyncNet loss function and a reconstruction loss function.

The processor 1010 inputs the output image obtained in operation S2500 and an output of a specific layer of the upsampling model into a multi-level SyncNet loss function defined in the present invention to calculate the value of the multi-level SyncNet loss function, and calculates the value of a reconstruction loss function based on the difference between the output image and a ground truth.

Hereinafter, the multi-level SyncNet loss function will be described.

In the conventional technologies (see reference [3]), in order to learn a visual-audio combination, the similarity between a mouth region in the final output image Î and an audio feature is calculated using a pre-trained SyncNet, and the similarity is used as a loss function. However, the experimental results show that when the SyncNet loss function is applied to the final output Î as in the conventional technologies, the performance of lip sync synchronization is improved but the visual quality of the generated result is degraded. On the other hand, when the SyncNet loss function is applied to an intermediate image I_{M}∈ [symbol] (an output of an upsampler before the final upsampler) generated in an intermediate operation before upsampling is completed, the visual quality of the generated result is not degraded but the lip sync synchronization performance is degraded. In order to alleviate this trade-off, unlike the conventional technologies, the present invention proposes a method of applying the SyncNet loss function to multi-layer outputs, i.e., provides a multi-level SyncNet Loss Function. The method of obtaining the multi-level SyncNet loss function is expressed in Equations 3 to 5.

$$s ( {f}_{t}^{v} , {f}_{t}^{a} ) = \frac{{f}_{t}^{v} \cdot {f}_{t}^{a}}{‖ {f}_{t}^{v} ‖ ‖ {f}_{t}^{a} ‖} \qquad [ Equation 3 ]$$

$${L}_{sync} = - log ( \frac{exp ( s ( {f}_{t}^{v} , {f}_{t}^{a} ) )}{exp ( s ( {f}_{t}^{v} , {f}_{t}^{a} ) ) + {\sum }_{j = 1}^{N} exp ( s ( {f}_{t}^{v} , {f}_{j}^{a -} ) )} ) \qquad [ Equation 4 ]$$

In Equations 3 and 4, fₜ^{v} and fₜ^{a} represent a visual feature and an audio feature at each time (t, referring to a different time step) obtained by inputting an output image Î (or I_{M}) and an audio feature a of each time t to a pre-trained SyncNet model, respectively. fⱼ^{a-} is an audio feature at a time (j other than a time t) not temporally aligned with a visual feature at a time t. That is, a loss function is applied in the form of contrastive loss by utilizing N temporally non-aligned audio features. That is, fₜ^{v} and fₜ^{a} form a positive pair, and fₜ^{v} and fⱼ^{a-} form a negative pair. A positive pair is a feature pair that the model needs to learn, and a negative pair is a feature pair that is not synchronized. The contrastive loss trains the model to generate an output value that is close to the positive pair and far from the negative pair. The processor 1010 reflects positive pairs and negative pairs in the loss function such that the lip sync video generation model may focus on synchronizing the mouth shape (visual information) with audio.

$${L}_{Multi - level Sync} = {\sum }_{l ∈ \{ 1 , L or 1 , n , .. , L \}} {L}_{Sync}^{l} \qquad [ Equation 5 ]$$

L¹_{sync} in Equation 5 is an L_{sync} loss function that uses an output image of an 1^{th} layer of the decoder and an audio feature. The outputs from the first and last layers of the decoder need to be used in the loss function, and in order to balance the visual quality of the generated result and the lip sync synchronization performance, outputs of intermediate layers may also be used in calculating the loss function. For reference, a layer of the decoder represents a pair consisting of each upsampler and a convolution element (Conv.) in a multi-layer convolutional network. Also, “toRGB” in FIG. 3 is a process of converting to three dimensions (channels). In the test for the present invention, the most significant trade-off between the visual quality and the lip sync synchronization performance occurred at the outputs of the first and last layers. Therefore, the present invention newly proposes a method of including the output of the first layer together with the last layer in the loss function to balance the visual quality and the lip sync synchronization performance.

Operation S2700 is an operation of calculating the value of a wavelet loss function.

The processor 1010 performs a wavelet transform on the output image Î and the ground-truth given for training, and inputs a result of the wavelet transform into a wavelet loss function defined in the present invention to calculate the value of the wavelet loss function.

As a result of analyzing the trade-off between the visual quality and the lip-sync synchronization performance of the output image of the lip-sync video generation model, it is confirmed that when only the multi-layer SyncNet loss function is applied, the reproduction performance in the high-frequency region degrade. In order to prevent such performance degradation, the present invention proposes a loss function in a frequency domain using wavelet transformation. The operation of the wavelet transformation is as follows.

$${f}_{LL} = [ \begin{matrix}1 & 1 \\ 1 & 1\end{matrix} ] , {f}_{LH} = [ \begin{matrix}- 1 & - 1 \\ 1 & 1\end{matrix} ] , \\ {f}_{HL} = [ \begin{matrix}- 1 & 1 \\ - 1 & 1\end{matrix} ] , {f}_{HH} = [ \begin{matrix}1 & - 1 \\ - 1 & 1\end{matrix} ] \qquad [ Equation 6 ]$$

Equation 6 represents frequency-specific pass filters of the Haar wavelet transform, in which the frequency LL is used as a filter to decompose the input image into a low frequency region, and LH, HL, and HH are used as filters to decompose the input image into high-frequency regions in the horizontal, vertical, and diagonal directions, respectively. The present invention, in order to further decompose the decomposed low-frequency region image using a wavelet transform, applies the wavelet transform in multiple layers, and uses the result for a wavelet-based loss function (hereinafter referred to as “a wavelet loss function”). The wavelet loss function is expressed in Equation 7.

$${L}_{wavelet} = {λ}_{LL} ‖ {\hat{W}}_{LL} - {W}_{LL} ‖ + {λ}_{LH} ‖ {\hat{W}}_{LH} - {W}_{LH} ‖ + {λ}_{HL} ‖ {\hat{W}}_{HL} - {W}_{HL} ‖ + {λ}_{HH} ‖ {\hat{W}}_{HH} - {W}_{HH} ‖ \qquad [ Equation 7 ]$$

In Equation 7, λ_{LL}, λ_{LH}, λ_{HL}, and λ_{HH} represent the weights of each wavelet coefficient. To explicitly compensate for the high-frequency region, the present invention sets λ_{HH} to a significantly large value compared to λ_{LL}, λ_{LH}, and λ_{HL} (for example, sets the other weights to 1 and sets λ_{HH} to 100) and performs training. The reason for setting λ_{HH} to a significantly large value compared to λ_{LL}, λ_{LH}, and λ_{HL} is to enable the lip-sync video generation model to generate an output image that is close to the ground-truth GT through a single training process by utilizing the wavelet loss function shown in Equation 7.

In Equation 7, Ŵ and W represent each frequency region obtained by applying wavelet transformation to the final output image (an output image) Î and the ground-truth given for training, respectively.

Operation S2800 is an operation of updating the parameters of the lip-sync video generation model.

The processor 1010 updates the parameters of the lip-sync video generation model based on the values of each loss function acquired from operations S2600 and S2700. For example, the processor 1010 may update the parameters of the NeRF included in the reconfiguration loss function encoder, the parameters of the transformer layer for cross-attention operation (including the weights of FFN and the linear projection weights), and the parameters of the convolution element (Conv) of the decoder, based on a weighted sum of the value of the multi-layer SyncNet loss function, the value of the reconfiguration loss function, and the value of the wavelet loss function. For reference, the weights of the wavelet coefficients may be fixed. That is, the weights of the wavelet coefficients may not be updated through training.

The method of training a lip-sync video generation model has been described above with reference to the flowchart presented in the drawings. While the above methods have been shown and described as a series of blocks for the purpose of simplicity, it is to be understood that the present invention is not limited to the order of the blocks, and that some blocks may be executed in a different order from that shown and described herein or executed concurrently with other blocks, and various other branches, flow paths, and sequences of blocks that achieve the same or similar results may be implemented. In addition, not all illustrated blocks are necessarily required for implementation of the method described herein.

Meanwhile, in the description with reference to FIGS. 2 and 3, each operation may be further divided into a larger number of operations or combined into a smaller number of operations according to examples of implementation of the present invention. In addition, even in the case of omitted content, the content of FIG. 1 may be applied to the content of FIGS. 2 and 3. In addition, the content of FIGS. 2 and 3 may be applied to the content of FIG. 1.

According to an embodiment of the present invention, a cross-attention operation between visual features and audio features is added to a lip-sync video generation model, and the model is trained by introducing a newly defined multi-level SyncNet loss function, and thus a lip-sync image that is synchronized by focusing only on the shape of the mouth can be generated.

In addition, according to an embodiment of the present invention, the model is trained by introducing a newly defined wavelet loss function, and thus the visual quality of a lip-sync image generated in a high-frequency region can be improved.

The effects of the present invention are not limited to those described above, and other effects that are not described above will be clearly understood by those skilled in the art from the above detailed description.

Although the present invention has been described in detail above with reference to exemplary embodiments, those of ordinary skill in the technical field to which the present invention pertains should be able to understand that various modifications and alterations may be made without departing from the technical spirit and scope of the present invention.

What is claimed is:

1. A method of training a lip-sync video generation model, the method comprising:
generating, by an apparatus for training a lip-sync video generation model, a visual feature and an audio feature using a deep learning-based neural radiance field (NeRF) and an audio feature extractor based on lip-sync target data including visual data and audio data;
combining, by the apparatus, the visual feature and the audio feature through a cross-attention operation to generate a visual-audio feature;
upsampling, by the apparatus, the visual-audio feature and generating an output image; and
performing, by the apparatus, training by inputting the output image to a predetermined loss function and updating parameters of the lip-sync video generation model based on a value of the predetermined loss function.

2. The method of claim 1, wherein the generating of the visual-audio feature includes:
generating, by the apparatus, a visual token and an audio token through dimensional reshaping of the visual feature and the audio feature, combining the visual token and the audio token to generate a visual-audio token, and performing the cross-attention operation by setting the visual token as a query of the cross-attention operation and setting the visual-audio token as a key and a value of the cross-attention operation.

3. The method of claim 1, wherein the loss function includes a SyncNet loss function.

4. The method of claim 1, wherein the generating of the output image includes inputting, by the apparatus, the visual-audio feature into an upsampling model based on a convolutional network including two or more layers, to generate the output image.

5. The method of claim 4, wherein the performing of the training includes inputting, by the apparatus, the output image and an output of a specific layer of the upsampling model into a multi-level SyncNet loss function.

6. An apparatus for training a lip-sync video generation model, the apparatus comprising:
a memory storing computer-readable instructions; and
at least one processor configured to execute the instructions,
wherein the at least one processor executes the instructions to:
generate a visual feature and an audio feature using a deep learning-based neural radiance field (NeRF) and an audio feature extractor based on lip-sync target data including visual data and audio data;
combine the visual feature and the audio feature through a cross-attention operation to generate a visual-audio feature;
upsample the visual-audio feature to generate an output image; and
input the output image to a predetermined loss function and update parameters of the lip-sync video generation model based on a value of the predetermined loss function.

7. The apparatus of claim 6, wherein the at least one processor is configured to generate a visual token and an audio token through dimensional reshaping of the visual feature and the audio feature, combine the visual token and the audio token to generate a visual-audio token, and perform the cross-attention operation by setting the visual token as a query of the cross-attention operation and setting the visual-audio token as a key and a value of the cross-attention operation.

8. The apparatus of claim 6, wherein the loss function includes a SyncNet loss function.

9. The apparatus of claim 6, wherein the at least one processor is configured to input the visual-audio feature into an upsampling model based on a convolutional network including two or more layers, to generate the output image.

10. The apparatus of claim 9, wherein the at least one processor is configured to input the output image and an output of a specific layer of the upsampling model into a multi-level SyncNet loss function in a process of updating the parameters of the lip-sync video generation model.
